(19) United States
(12) Patent Application Publication
(10) Pub. No.: US 2008/0248790 A1
(43) Pub. Date: Oct. 9, 2008

(54) System and method for providing caller name or caller information to a callee via call signaling

(75) Inventors: Shai Ophir, Moshav Ein-Vered (IL); Shachar Ovadia, Ramat-Gan (IL); Shlomo Wolfman, Hod-HaSharon (IL)

Correspondence Address: Martin D. Moynihan;PRTSI, Inc., P.O. Box 16446, Arlington, VA, 22215, US

(73) Assignee: StarHome GmbH, Zurich (CH)

(21) Appl. No.: 12/078,713

(22) Filed: Apr. 3, 2008

Related U.S. Application Data
(60) Provisional application No. 60/924,812, filed on May 31, 2007.
(60) Provisional application No. 60/907,462, filed on Apr. 3, 2007.

(51) Int. Cl. H04M 3/42

(52) U.S. Cl. 455/415

(57) ABSTRACT

A system for transferring alphanumeric information to a mobile device, embedded with the call signaling, where the mobile device is able to extract the information from the incoming call and display it on the device, the information containing at least one of: {caller's name, caller's brand name, caller's information, caller's brand information}, the information is being added to the call by a network server controlling the call using IN triggers, or being added to the call directly by the caller's mobile device.

### RELATIONSHIP TO EXISTING APPLICATIONS

This present application claims the benefit of U.S. Provisional Patent Application Nos. 60/907,462, filed on Apr. 3, 2007, and 60/924,812, filed on May 31, 2007, the contents of which are hereby incorporated by reference.

### FIELD AND BACKGROUND OF THE INVENTION

Currently, the CLI of a telephony call contains the caller party number (also known as the originating number or the “A number”). The CLI is one of SS7 parameters of the call, embedded in the call signaling (such as ISUP, but not only). If the CLI is not hidden by the caller party, it is usually transferred to the destination, and is displayed on the called party device, if it has a proper display capability. Sometime the CLI is omitted by an international carrier, but over the years more and more carriers transfer the CLI as well.

The CLI contains numeric information. In theory, it may also contain 4 alphanumeric letters: A, B, C, D but currently this functionality is not being used as far as we know, and has no value for the end user anyhow, since there are only 4 characters available. When the call reaches the end user (the receiver, or the “B party”), she usually sees the caller's number. Only if the caller is known to the receiver, and her number is already stored in the handset address book, then the mobile handset usually displays the name associated with the number.

There are some methods discussing the sending of caller information to the mobile handset, in parallel with the call. This kind of information can be sent via SMS, USSD, or via IP. A client application installed on the handset can receive and display the information. However these solutions suffer from the problem of lack of synchronization between the call and the additional information, which do not reach the handset necessarily at the same time. Also, in case of SMS (“flash SMS” for example), the user interface is not synchronized as well. The call reaches the handset, the handset rings, then the flash SMS reaches the handset as well, the screen is captured by the flash SMS (or hidden by the call alert), then the user needs to confirm the SMS, in parallel of answering the call. The user interface is problematic.

### SUMMARY OF THE INVENTION

The current invention resolves these problems by embedding the additional caller/brand information in the call, instead of sending the information via SMS or another notification service.

This invention describes a way to transfer alphanumeric information to the mobile device, embedded with the call signaling. This information may contain the name of the caller, or another textual identification of the caller. The text will be displayed on the B party device, even if the B party does not know the caller in advance, and does not hold the caller number in the phone address book. This method can be used for transferring commercial information, such as the brand name, if the call is being placed by a commercial party. The caller's or brand's name can be taken from a directory server, located at the telephony network.

The information that is delivered to the callee (the destination of the call) can be also extracted from the mobile handset of the caller. For example, the caller can specify “Urgent”, or “Not urgent” (meaning, “answer only if you have some free time”), or any other message.

This invention can be related to mobile operator, as well as for fix-line operator, broadband service provider, internet provider or any other type of operator that is involved in voice call transmission.

The invention can be related to any type of device, mobile, fix-line device, IP-based device used for internet connection, and any device that can receive a voice call.

Implementation of the method and/or system of embodiments of the invention can involve performing or completing selected tasks manually, automatically, or a combination thereof. Moreover, according to actual instrumentation and equipment of embodiments of the method and/or system of the invention, several selected tasks could be implemented by hardware, by software or by firmware or by a combination thereof using an operating system.

For example, hardware for performing selected tasks according to embodiments of the invention could be implemented as a chip or a circuit. As software, selected tasks according to embodiments of the invention could be implemented as a plurality of software instructions being executed by a computer using any suitable operating system. In an exemplary embodiment of the invention, one or more tasks according to exemplary embodiments of method and/or system as described herein are performed by a data processor, such as a computing platform for executing a plurality of instructions. Optionally, the data processor includes a volatile memory for storing instructions and/or data and/or a non-volatile storage, for example, a magnetic hard-disk and/or removable media, for storing instructions and/or data. Optionally, a network connection is provided as well. A display and/or a user input device such as a keyboard or mouse are optionally provided as well.

### BRIEF DESCRIPTION OF THE DRAWING

The invention is herein described, by way of example only, with reference to the accompanying drawings. With specific reference now to the drawings in detail, it is stressed that the particulars shown are by way of example and for purposes of illustrative discussion of the preferred embodiments of the present invention only, and are presented in the cause of providing what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice.

In the drawings:

FIG. 1 describing the signaling flow of the main embodiment of the invention: fetching the caller's name from a network server, encoding it and inserting it to the call signaling, so the mobile handset client can fetch it, decode it and display it on the screen at the same time the call reaches the callee.

### DESCRIPTION OF THE PREFERRED EMBODIMENTS

In general, the present invention deals with a system and method for transferring a caller's or brand's name or caller's/brand's information to the callee, where the information is embedded in the call signaling, hence can be displayed by the mobile handset just in the time the call is received by the handset. The caller's name can be fetched by a network server, based on the caller's ID (unless it is hidden by the caller). The caller information can be sent from the caller's device directly, without a network server intervention. A client in the caller's side encodes the information into the call, and another client at the callee's side fetches and decodes the information while the call reaches the mobile device.

NOTE: the client on the mobile handset does not have to be an external client, installed on the device operating system. It can be an internal feature of the mobile device, a client which is implemented by the mobile device manufacturer.

The information can be transferred to the handset in the CLI parameter itself, or in another parameter of the call. If the CLI is being used for this purpose, then the original CLI is not kept, and can not be used later for reply, or send SMS, etc. Therefore it is recommended to use another parameter for this purpose. Such a parameter can be the CLI sub-address parameter that is carried by the ACCESS TRANSPORT (AT) ISUP field, or any other parameter that can be inserted into the call on the network side, and then fetched by a handset client application. Another potential parameter is the Generic Name (GN) ISUP parameter.

The MSC serving the callee can also use DTAP (Direct Transfer Application Protocol) signaling for sending the information to the mobile device, over the air.

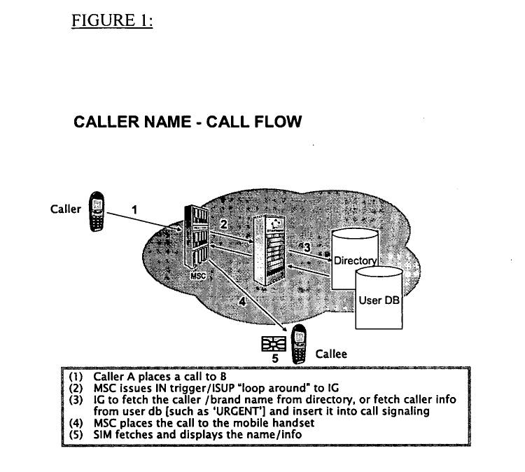

Reference is made now to FIG. 1, which describes the flow of the service—the Caller's Name service:
(1) Caller A places a call to B
(2) MSC (Mobile Switching Center) issues IN trigger to IG (IntelliGate, gateway platform, the server implementing this invention).
(3) IG to fetch the caller/brand name from directory, or fetch caller info from user db [such as ‘URGENT’ ] and insert it into call signaling. If the information can not be modified via IN control, the call can be routed to the IG via ISUP “loop around”. (“Loop around” is a method where the call signaling reaches the gateway platform, but not the actual voice, which is “looped back” to the MSC, in order to avoid voice overload at the IG).
(4) MSC places the call to the mobile handset
(5) SIM fetches and displays the name/info

The client application can be a SIM toolkit application, a Symbian application, or any other application that has call control capabilities. The application will be capable of receiving MT (Mobile Terminated) trigger for a call reaching the mobile device, and then will fetch the information from the call parameters and display the textual information on the screen.

In case of a SIM toolkit application, the standard ETSI 11.14 defines the MT call event, and specifies that the envelope containing the call parameters that can be provided by the handset to the SIM toolkit application will contain the “address” and “subaddress” fields. The address field contains the Calling Party numbers as received by the handset. The subaddress field contains the subaddress of the calling party. This field can be used for the purpose of transferring textual information. The information will be inserted to the call by a network server, as described in the following, and will use a text-to-number encoding method, as described in the following as well.

Encoding textual information into a numeric value:

The following describes one method for encoding alphabetic characters in a numeric value (the “26 basis”). There are several other methods for such a purpose; the invention is not limited to this particular method only.

The information will be inserted into the call by a network server (see the next section), and will be extracted as the subaddress parameter in case of a SIM toolkit application. However note this is only one method among equivalent other methods for transferring information, embedded in a call, to the application installed on the mobile device.

The subaddress field for example may contain a number of at least 12 digits (such as an MSISDN, a mobile station number including a country code and a network code). In English for example, there are 26 characters. A string of 8 English characters “abcdefgh” can be represented uniquely by the following number: (where ** is the sign of power)

a*26**0+b*26**1+c*26**2+d*26**3+e*26**4+f*26**5+g*26**6+h*26**7

The max value of such a number does not exceed a 12 digits number. In fact it is 217,180,147,158. Therefore, if the parameter will be replaced with a value representing a character string, in the method of “26-basis”, this value transferred to the terminal receiving the call. At the terminal, a simple application such as a SIM applet for a GSM handset, or a Symbian/Microsoft OS/Brew or any other application can decode the number, convert it into the character string uniquely represented by the value of the number, and then display the string at the same time the call is being received by the terminal.

In oppose to different solutions that transfer call information to the terminal in parallel to the call signaling, such as via IP connection, this method transmit the information embedded in the call signaling. There is no need to correlate between the actual call and the second path; there is no problem of timing, such as in the case of sending the information via SMS, for example.

The information may also contain pre-call information, such as “URGENT”, or any commercial information, as mentioned before. The following is an implementation of one scenario only, among many potential scenarios.

Inserting the encoded information into the call signaling using a network application server:

An IN (Intelligent Network) trigger will be assigned to mobile subscribers who subscribed for the service. The trigger is received by the application server located on the network, connected to the switch.

The application server may access a global directory, or a global address book, or any other database that contains caller information. The database or directory may contain all subscriber numbers belonging to the operator, or belonging to all operators in that country, or in other regions, including mobile, fix-line and other operators. The directory may also contain brand names, such as a Yellow Pages directory.

The application server receives the name associated with this number from the database/directory. Then it encodes the first 8 characters (can be also less characters or more, if the call parameter may contain more than 12 digits, as described in the example above) into a number, as described in the above. This number is then inserted into the call parameter. This field might be the ODN parameter (Original Dialed Number), or an extension of the CLI number, or any other parameter that resulted in the subaddress field for the SIM toolkit application, or resulted in any other parameter that can be fetched by any other client application.

The interface with the network switch can be done also via ISUP, ISUP “loop around”, CAMEL, or any other call control methods.

When the call reaches the handset, the SIM applet or other client receives an incoming call trigger, fetches the subaddress parameter value (or any other parameter accordingly), decodes it back into a string (by simple division to 26 and take the remainders each time, which is the reverse of the encoding method described in the above) and displays the string on the device terminal.

Device Application:

The client on the handset can be any of the clients described in the above. In the case of the SIM toolkit, this can be a SIM applet, which will be associated with the MT call control event, and will be able to fetch the subaddress parameter, or any other value that can be fetched from the incoming call parameters, and contains the value inserted by the network server. Then the applet will display the value on the display of the device. In addition, the client can be an internal client, a feature of the mobile device manufacturer that supports name display, so it doesn't have to be a separate client installed on top of the mobile operating system.

### ADDITIONAL EMBODIMENTS

The information that is delivered to the callee (the destination of the call) can be also extracted from the mobile handset of the caller. The caller's handset can have a client application installed, either a SIM applet, or a Symbian, or any client as described in the following. This client can install the call information into the subaddress parameter of the call, or any other parameter that is available for this purpose. The client should be able to get control of the call made by the end user, and then to insert the parameters to the call, before it goes from the handset to the network.

The parameter to use for the additional call information might be the CLI subaddress, or as it is called “subaddress”, in the ETSI 11.14 spec, in the description of the “event download—MT call”. However it could be any other parameter available for the handset. When dialing, the caller should be able to use a DN (Dialed Number) suffix, in order to transfer textual messages to the callee. For example, if the caller dials the number and adds a ‘*’ sign, the platform at the network will get an INAP trigger, or the call will be routed to that platform via ISUP, or any other means, and the platform will insert the value corresponding to the word “URGENT” into the subaddress parameter, and then this text will be displayed on the screen along with the CLI of the caller.

The caller will be able to use a suffix to indicate that her own name will be included in the call, in the same technique described in the previous section. In this case, the platform will extract the caller name from the database. The difference is that now the caller decides, per call, if she wants her name to be displayed at the destination. Of course the callee should have the appropriate client installed on the handset as well.

The algorithm specified for “encoding” the textual information into a number is not the only method. If there are 20 or even 12 bytes available for the “subaddress” field, then there is enough space for using a byte per character, so there is no need for special decoding. The client will simply use the ASCII value of each one of the bytes for displaying the alphanumeric character.

The terms “comprises”, “comprising”, “includes”, “including”, “having” and their conjugates mean “including but not limited to”. This term encompasses the terms “consisting of” and “consisting essentially of”.

As used herein, the singular form “a”, “an” and “the” include plural references unless the context clearly dictates otherwise.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination or as suitable in any other described embodiment of the invention. Certain features described in the context of various embodiments are not to be considered essential features of those embodiments, unless the embodiment is inoperative without those elements.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention. To the extent that section headings are used, they should not be construed as necessarily limiting.

What is claimed is:

1. A system for providing call information to a callee device, the call information being embedded in alphanumeric information transferred to the callee device with the call signaling, the callee device being configured to extract the call information from the alphanumeric information with an incoming call and display said call information on the device, the system further comprising a network server configured for:
a) adding the call information to the call signaling and
b) controlling the call using IN triggers.

2. The system of claim 1, wherein a caller device is configured to add said call information to the call signaling.

3. The system of claim 1, wherein the call information comprises at least one of: the caller's name, the caller's brand name, the caller's information, the caller's brand information.

4. The system of claim 1, wherein said network server is configured to fetch the caller's name or the caller's brand name from a public directory server.

5. The system of claim 1, wherein said call information comprises an urgency level indication for the callee.

6. The system of claim 1, wherein said callee device of claim 1 is equipped with a SIM toolkit applet, able to receive an MT (Mobile Terminated) call event, and wherein the call information is extracted from a subaddress field of the incoming call.

7. The system of claim 1, wherein a caller device comprises a SIM toolkit applet with call control capabilities, which inserts the call information to a “subaddress” field of an outgoing call.

8. The system of claim 1, wherein said call information is encoded into the CLI-subaddress call parameter, then carried by an ACCESS TRANSPORT (AT) ISUP field, that contains a numeric value of at least 12 digits, the textual information being encoded into a number by using a base 26 representation, such that 12 digits provides enough space for at least 8 characters.

9. The system of claim 1 wherein said call information is stored and transferred by the ISUP parameter Generic Name (GN) of the IAM message.

10. The system of claim 1, wherein an MSC (Mobile Switch Center) serving the callee uses DTAP (Direct Transfer Application Protocol) signaling for transferring the information to the callee device.

11. A method for providing call information to a callee device, comprising:
embedding call information in alphanumeric information being transferred to the callee device with call signaling, thereby to enable the callee device to extract the call information from the alphanumeric information with an incoming call and to display the call information on the device, said embedding being carried out by a network server which additionally controls the call using IN triggers.

12. A method for providing call information to a callee device, comprising:
embedding call information in alphanumeric information being transferred to the callee device with call signaling, thereby to enable the callee device to extract the call information from the alphanumeric information with an incoming call and to display the call information on the device, said embedding being carried out by a callee telephony device.
